(19) United States
(12) Patent Application Publication
(10) Pub. No.: US 2016/0015026 A1
(43) Pub. Date: Jan. 21, 2016

(54) ANTIMICROBIAL GLASS AND METHOD OF PREPARING ANTIMICROBIAL GLASS

(71) Applicant: Samsung Display Co., Ltd., Yongin-city (KR)

(72) Inventors: Hoi Kwan LEE, Anseong-si (KR); Seung Ho KIM, Asan-si (KR); Seung KIM, Seongnam-si (KR); Ik Hyung PARK, Suwon-si (KR); Jong-Hoon YEUM, Seoul (KR)

(21) Appl. No.: 14/537,533

(22) Filed: Nov. 10, 2014

(30) Foreign Application Priority Data
Jul. 17, 2014 (KR) 10-2014-0090563

(51) Int. Cl. A01N 25/08; B05D 3/06; A01N 59/16

(52) U.S. Cl. CPC A01N 25/08; A01N 59/16; B05D 3/06

(57) ABSTRACT

The present disclosure relates to a method of preparing an antimicrobial glass, which includes: preparing a glass substrate; preparing a dry paste; selectively coating the dry paste at least a portion of the glass substrate; heat-treating the coated glass substrate after the coating; and cleaning the heat -treated glass substrate, wherein the preparation of the dry paste includes preparing a diluted solution by diluting a salt including silver ions or copper ions in water, and adding a metal oxide to the diluted solution, and an antimicrobial glass prepared according to the method.

### CROSS-REFERENCE TO RELATED APPLICATION

This application claims priority to and the benefit under 35 U.S.C. §119(a) of Korean Patent Application No. 10-2014-0090563, filed in the Korean Intellectual Property Office on Jul. 17, 2014, the entire disclosure of which is incorporated herein by reference.

### BACKGROUND

1. Field

A method of preparing an antimicrobial glass and an antimicrobial glass prepared thereby are disclosed.

2. Discussion of the Background

Glass is widely used as an interior/exterior building material due to its transparent and elegant characteristics. Glass is also widely used as a surface material for electronic devices, is such as mobile phones and the like, electronic appliances, such as refrigerators, air conditioners, and the like, and tableware, furniture, and the like, due to available supply of tempered glass and heat-resistant glass, which are prepared to have increased strength and thermal stability. Glass in electronic devices is often exposed to sweat, saliva, dirt, grease, cigarette smoke, moisture, and the like, such that the glass may provide an attractive environment for bacteria growth, which may be dangerous to a user.

As a result, an effort to prepare an antimicrobial glass by applying antimicrobial characteristics to glass has been made.

For example, methods of preparing antimicrobial glass substrate by dipping glass powder heated to near a transition temperature in an ion exchange solution, such as a silver salt aqueous solution, have been proposed. In such method, silver ions may be exchanged with sodium ions in the glass powder to increase antimicrobial properties. However, this method may be dangerous since the glass is put in the aqueous solution while at a high temperature. Further, only powder-shaped glass may be available from such method since a heated glass sheet may break or crack when it contacts the aqueous solution.

In addition, the method of preparing an antimicrobial glass by dipping glass in a solution may cause a defect due to elution of ions since even a part of the glass not requiring an antimicrobial function is antimicrobial-treated.

### SUMMARY

Exemplary embodiments of the present invention provide a method of preparing an antimicrobial glass by selectively coating a dry paste only on a part requiring or desired to be an antimicrobial treatment.

Exemplary embodiments provide method of preparing an antimicrobial glass capable of selectively performing an antimicrobial treatment in a part or portion requiring or desired to be antimicrobial by using a dry paste instead of a wet method of dipping a glass substrate in a molten salt and the like, and may provide an antimicrobial glass having decreased compression stress loss and having excellent transmittance.

Additional features of the invention will be set forth in the description which follows, and in part will be apparent from the description, or may be learned by practice of the invention.

Exemplary embodiments provide a method of preparing an antimicrobial glass which includes: preparing a glass substrate; preparing a dry paste; selectively coating the dry paste on at least a portion of the glass substrate; heat-treating the coated glass substrate after the coating; and cleaning the heat-treated glass substrate, and herein, the preparation of the dry paste includes preparing a diluted solution by diluting a salt including silver ions or copper ions in water, and adding a metal oxide to the diluted solution.

Exemplary embodiments provide an antimicrobial glass prepared according to the method.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further is understanding of the invention and are incorporated in and constitute a part of this specification, illustrate exemplary embodiments of the invention, and together with the description serve to explain the principles of the invention.

FIG. 1 is a flowchart showing a method of preparing an antimicrobial glass according to exemplary embodiments.

FIG. 2 is a drawing showing a glass substrate selectively coated with a dry paste according to exemplary embodiments.

FIG. 3 is a photograph showing the glass substrate selectively coated with a dry paste according to exemplary embodiments.

FIG. 4 is a schematic view showing an ion exchange reaction of the glass substrate selectively coated with the dry paste according to exemplary embodiments.

### DETAILED DESCRIPTION OF THE ILLUSTRATED EMBODIMENTS

The present disclosure will be described more fully hereinafter with reference to the accompanying drawings, in which exemplary embodiments of this disclosure are shown. However, this disclosure may be embodied in many different forms and is not construed as limited to the exemplary embodiments set forth herein.

In the drawings, the thickness of layers, films, panels, regions, etc., are exaggerated for clarity. Like reference numerals designate like elements throughout the specification. It will be understood that when an element, such as a layer, film, region, or substrate, is referred to as being “on” another element, it can be directly on the other element or intervening elements may also be present. In contrast, when an element is referred to as being “directly on” another element, there are no intervening elements present.

In addition, unless explicitly described to the contrary, the word “comprise” and variations such as “comprises” or “comprising” will be understood to imply the inclusion of stated elements but not the exclusion of any other elements. Further, in the specification, “on” indicates positioned on the top or beneath an object and not necessarily always positioned on the top of the object based on a gravity direction.

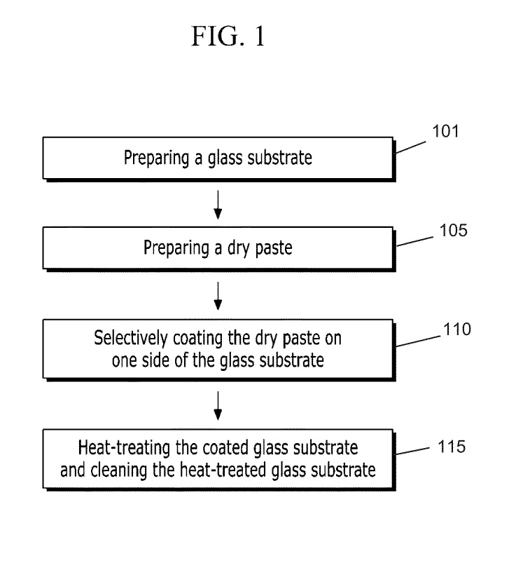

Referring to FIGS. 1 to 4, the method of preparing an antimicrobial glass is illustrated.

FIG. 1 is a flowchart showing the method of preparing an antimicrobial glass according to exemplary embodiments.

As shown operation 101 in FIG. 1, a glass substrate is prepared. The glass substrate may be a tempered glass substrate. The glass substrate may be prepared by dipping the glass substrate in a molten salt. The molten salt may include potassium ions. For example, the glass substrate may be prepared by dipping the glass substrate in a KNO₃ salt solution. An ion exchange reaction in which K⁺ is substituted for Li⁺, Na⁺, and the like on the surface of the substrate occurs, and may reinforce the surface of the glass substrate.

In operation 105, a paste for selectively coating at least one side or portion of the glass substrate is prepared. The paste may be a dry paste.

The preparation of the dry paste includes preparing a diluted solution by diluting a salt including silver ions and/or copper ions in water. The preparation of the dry paste further includes adding a metal oxide to the diluted solution. For example, the dry paste may be prepared by adding about 1 g to about 100 g of AgNO₃ to about 100 L of distilled water to prepare a diluted AgNO₃ solution, and then adding about 10 g to about 100 g of a metal oxide, for example, a zinc oxide, thereto.

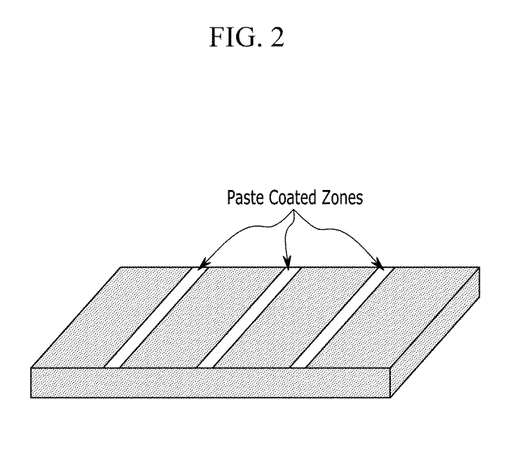

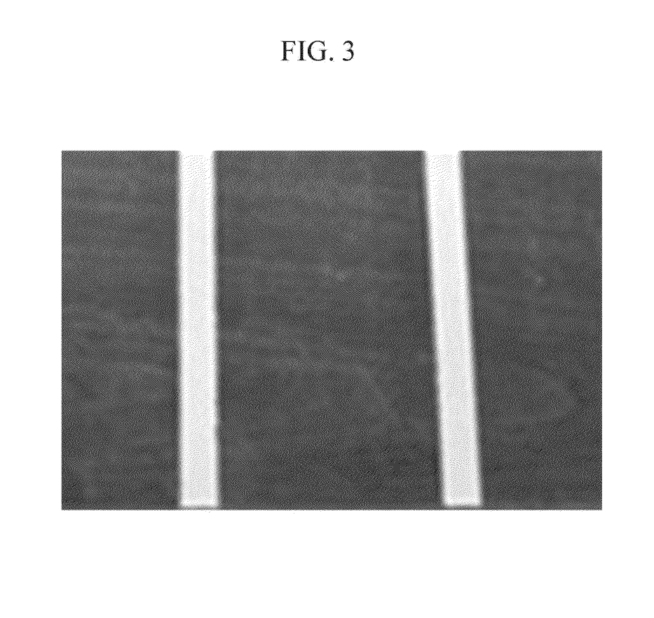

In operation 110, as shown in FIGS. 2 and 3, the dry paste is selectively coated on at least one side of the glass substrate.

The selective coating of the dry paste on at least one side of the glass substrate is performed by using a brush or the like on a part of the glass substrate determined to have an antimicrobial treatment on the at least one side of the glass substrate. The selective coating of the dry paste may be on only one side or portion of the glass substrate or may be on an entire side or the entire surface of the glass substrate; in other words, the selective coating of the dry paste on the glass substrate allows for selected portions of the glass substrate to receive the antimicrobial treatment.

A conventional method of dipping a glass substrate in a molten salt or the like may cause elution of silver ions from a part not intended to have an antimicrobial treatment due to the antimicrobial treatment on both sides of the glass substrate, and increase a compression stress loss in the following heat treatment due to the antimicrobial treatment on both sides of the glass substrate.

However, the method of preparing an antimicrobial glass according to exemplary embodiments by selectively performing an antimicrobial treatment on one side of a glass substrate decreases the effects of the antimicrobial treatment on the properties of the glass substrate.

Specifically, the dry paste is selectively coated on at least one side or portion of the glass substrate in operation 110, and the coated glass substrate is heat-treated in operation 115.

The heat treatment may include radiation at a high frequency. For example, the heat treatment may include a primary heat treatment in which at least a portion of, for example, is one whole side, of the glass substrate is heated to about 300° C. by using an electric heating furnace, and a secondary heat treatment in which at least the side or portion of the glass substrate coated with the dry paste is heated to about 450° C. by radiating a high frequency radiation on the glass substrate. However, aspects are not limited thereto such that only specific portions of the glass substrate may be heated to the appropriate temperatures. For example, in the secondary heat treatment, only the side or portion of the glass substrate coated with the dry paste may be heated to about 450° C.

The primary heat treatment may be a preliminary heat treatment for an environmental temperature, and may be performed by using an electric heating furnace or the like rather than a high frequency radiation.

When the primary heat treatment is performed at a higher temperature, the secondary heat treatment, that is, the irradiation of the glass substrate with a high frequency radiation, may be performed for a shorter time. For a glass substrate, its internal and external temperatures both constantly increase as the heat treatment is performed longer, but they sharply increase over a critical temperature, and thus a compression stress becomes larger.

Accordingly, when the heat treatment is performed at a temperature less than or equal to the critical temperature, an antimicrobial glass may be prepared while decreasing the compression stress. The critical temperature may be, for example, in a range of about 400° C. to about 450° C. For example, the heat treatment may include a primary heat treatment in which at least one side of a glass substrate is heated to about 300° C. by using an electric heating furnace, and a secondary heat treatment in which at least the side or portion of the glass substrate coated with the dry paste is heated to a range of about 400° C. to about 450° C. by irradiating the glass substrate with a high frequency wave.

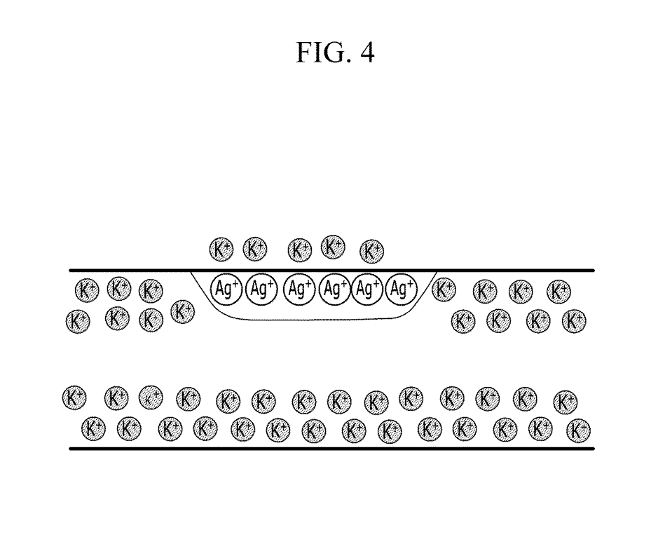

As shown in FIG. 4, an ion exchange reaction occurs between ions in the dry paste and ions in the glass substrate coated with the dry paste through the primary and secondary heat treatments.

The secondary heat treatment may be performed for about 5 minutes to about 15 minutes, and such times may vary depending on a temperature for the primary heat treatment. In other words, when the primary heat treatment is performed at a lower temperature, the secondary heat treatment is performed for a longer time, and when the primary heat treatment is performed at a higher temperature, the secondary heat treatment is performed for a shorter time.

The high frequency radiation may have a frequency ranging from about 2 GHz to about 8 GHz. An ion exchange reaction between ions in the dry paste and ions in the side or portion of the glass substrate coated with the dry paste may appropriately occur by radiating a high frequency radiation at the range of about 2 GHz to about 8 GHz.

The high frequency radiation may be VFM (variable frequency microwave).

In operation 115, after the heat treatment, the glass substrate is cleaned. The cleaning may be performed with water.

The method of preparing an antimicrobial glass according to exemplary embodiments may further include drying the coated glass substrate after the coating of the paste on the glass substrate but before the heat treatment of the glass substrate.

The drying may be performed to remove moisture on the glass substrate after the selective coating on the glass substrate, and the drying may be performed at room temperature, for example, at about 15° C. to about 30° C., for about 3 hours to about 9 hours.

The glass substrate may be a tempered glass substrate.

The glass substrate may be prepared by dipping the glass substrate in a molten is salt.

The molten salt may include potassium ions.

For example, the glass substrate may be prepared by dipping the glass substrate in a KNO₃ salt solution. Herein, an ion exchange reaction in which K⁺ is substituted for Li⁺, Na⁺, and the like on the surface of the substrate occurs, and may reinforce the surface of the glass substrate.

Hereinafter, aspects of the present disclosure are illustrated in more detail with reference to examples. However, these examples are exemplary, and the present disclosure is not limited thereto.

Manufacture of Antimicrobial Glass

(Manufacture of Dry Antimicrobial Paste)

A diluted AgNO₃ solution was prepared by adding 5 g of AgNO₃ to 100 L of distilled water. 45 g of ZnO was added to the diluted AgNO₃ solution, thereby preparing a dry paste.

(Manufacture of Antimicrobial Glass)

A glass substrate was dipped in a KNO₃ salt solution, thereby preparing a tempered glass.

The dry antimicrobial paste was coated by using a brush on one side of the tempered glass for an antimicrobial treatment.

Then, the coated, tempered glass was dried at room temperature at 25° C. for 6 hours to remove moisture.

One side of the dried tempered glass substrate was heated to 300° C. by an electric is heating furnace, and subsequently irradiated by a VFM (variable frequency microwave) for 10 minutes, until the internal temperature of the glass substrate reached 450° C.

Then, the dry antimicrobial paste remaining on the tempered glass substrate was washed away with water, thereby preparing a tempered antimicrobial glass.

UV Transmittance Rate, Ion Exchange Inspection and Surface Compression Stress Analysis

The antimicrobial-treated tempered glass showed UV transmittance of greater than or equal to 90% and excellent UV transmittance after the antimicrobial treatment compared with UV transmittance of a tempered glass before the antimicrobial treatment.

When the antimicrobial tempered glass was heat-treated at 500° C., the glass was changed from colorless to having a color, and showed decreased UV transmittance at a wavelength of 420 nm. In such case, silver ions (Ag⁺) on the surface of the antimicrobial tempered glass surface were changed into a silver metal (Ag) according to an ion exchange reaction.

The tempered glass had a surface compression stress of 700 MPa before the antimicrobial treatment and had a surface compression stress of greater than or equal to 600 MPa after the antimicrobial treatment, and thus showed a small surface compression stress decrease.

The antimicrobial glass prepared in a method according to exemplary embodiments showed higher UV transmittance than an antimicrobial glass prepared in a conventional method, such as a dipping method in a molten salt or the like, and smaller decrease in a surface compression stress compared with the antimicrobial glass prepared in a conventional method.

Although a few exemplary embodiments of the present invention have been is shown and described, aspects of the invention are not limited thereto. Instead, it would be appreciated by those skilled in the art that changes may be made to these exemplary embodiments without departing from the principles and spirit of the invention, the scope of which is defined by the claims and their equivalents.

What is claimed is:

1. A method of preparing an antimicrobial glass, the method comprising:
preparing a glass substrate;
preparing a dry paste;
selectively coating the dry paste on at least a portion of the glass substrate;
heat-treating the coated glass substrate after the coating; and
cleaning the heat-treated glass substrate,
wherein the preparation of the dry paste comprises:
preparing a diluted solution by diluting a salt comprising silver ions or copper ions in water, and
adding a metal oxide to the diluted solution.

2. The method of claim 1, wherein the metal oxide is a zinc oxide.

3. The method of claim 1, wherein the heat treatment is performed by irradiating the coated glass substrate with a high frequency radiation.

4. The method of claim 3, wherein the heat treatment comprises a primary heat treatment in which one whole side of the glass substrate is heated to 300° C. by an electric heating furnace, and a secondary heat treatment in which only the at least one portion of the glass substrate coated with the dry paste is heated to 450° C. by the irradiating the coated glass s substrate with the high frequency radiation.

5. The method of claim 3, wherein the heat treatment comprises a primary heat treatment in which the glass substrate is heated to 300° C., and a secondary heat treatment in which a portion of the glass substrate coated with the dry paste is heated to 450° C.

6. The method of claim 3, wherein the high frequency radiation has a frequency ranging from about 2 Hz to about 8 GHz.

7. The method of claim 3, wherein the high frequency radiation comprises VFM (variable frequency microwaves).

8. The method of claim 4, wherein the secondary heat treatment is performed for about 5 minutes to about 15 minutes.

9. The method of claim 1, further comprising drying the coated glass substrate between the coating and the heat-treating.

10. The method of claim 9, wherein the drying of the coated glass substrate is performed at about 15° C. to about 30° C. for about 3 hours to about 9 hours.

11. The method of claim 1, wherein the glass substrate is a tempered glass substrate.

12. The method of claim 11, wherein the tempered glass substrate is prepared by dipping the glass substrate in a molten salt.

13. The method of claim 12, wherein the molten salt comprises potassium ions.

14. The method of claim 1, wherein the dry paste is selectively coated on only one side of the glass substrate.

15. An antimicrobial glass prepared according to claim 1.
